(19) United States
(12) Patent Application Publication
(10) Pub. No.: US 2019/0102573 A1
(43) Pub. Date: Apr. 4, 2019

(54) THEATER EARS ANDROID APP SENSITIVE DATA MANAGEMENT

(71) Applicant: Theater Ears, LLC, Boca Raton, FL (US)

(72) Inventor: Vineet Kashyap, New Delhi (IN)

(21) Appl. No.: 15/720,013

(22) Filed: Sep. 29, 2017

(51) Int. Cl. G06F 21/62; G06F 9/45

(52) U.S. Cl. CPC G06F 21/6245; G06N 99/005; G06F 8/41

(57) ABSTRACT

In one aspect of the embodiment, the method includes an algorithm to derive sensitive data values through a series of complex calculations based on various iterations of byte dissociation followed by complex mathematical operations and byte concatenations. In another aspect of the embodiment, the sensitive data management algorithm protects data by creating a library coded in the C programming language which on decompilation gives native machine learning code. This sensitive data protection library is coded and compiled as .so files which reside at the core level deep inside the application layer, thus being only accessible through the application layer code by proper access interface layer.

### BACKGROUND OF THE INVENTION

### Field of the Invention

The present disclosure is related to data resource management systems and more particularly to software-based data security systems, sensitive data management systems and multi layered security framework systems.

### Description of the Related Art

Sensitive data can be defined as information that is protected against unwarranted disclosure. Examples of such data include personal, financial, and government-protected information like Social Security numbers and banking information. Due to the sensitive nature of personal and financial information, data is a popular target for hackers. Thus, it is necessary for safeguards protecting sensitive data to exist.

As society has become more reliant on digital information, data breaches have become larger in number and impact. Despite advanced security techniques, many vulnerabilities exist in many current sensitive data management systems. In 2014, there were nearly five times as many data breaches in the United States as there were in 2005. Without extra safeguards protecting data, various information can be easily extracted and compromised during a data breach. Thus, there exists a need for more advanced and more secure data management systems.

### BRIEF SUMMARY OF THE INVENTION

Embodiments of the present invention address deficiencies of the art in respect to the protection and safeguarding of sensitive information and provide a novel and non-obvious method, system and algorithm for protecting sensitive information. In an embodiment of the invention, a method for sensitive data management includes a mobile application that provides data protection through decompiled machine language codes and non-direct storage of data strings using complex calculations-based derivation of data. The method additionally includes bundling sensitive data along with an Android APK (executable) so that only the application has access to the sensitive data. The method yet further includes compiling the sensitive data library in a file within the application layer and determining whether access is to be granted.

In one aspect of the embodiment, the method includes an algorithm to derive sensitive data values through a series of complex calculations based on various iterations of byte dissociation followed by complex mathematical operations and byte concatenations. In another aspect of the embodiment, the sensitive data management algorithm protects data by creating a library coded in the C programming language which on decompilation gives native machine learning code. This sensitive data protection library is coded and compiled as .so files which reside at the core level below the application layer, thus being only accessible through the application layer code by proper access interface layer.

More specifically, in one embodiment, a method for sensitive data management includes loading source code defining a computer program such as a mobile application, selecting data to be utilized by the computer program during execution in a computing device such as a mobile phone, compiling the source code into the computer program, packaging the computer program into a package with the selected data disposed below an application layer of the package and deploying the package over a computer communications network to the computing device. As well, the method additionally may include computing a checksum for the computer program, bundling the checksum with the package and in response to a request by the computer program during execution in the computing device to access the selected data, retrieving the bundled checksum from the package, recomputing a checksum of the computer program, comparing the bundled checksum to the recomputed checksum and permitting access to the selected data only if the bundled checksum and recomputed checksum are determined to have the same value. Optionally, the package may be an Android-type operating system Android package kit (APK) extended from a Java type archive.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for sensitive data management using an Android application;

FIG. 2 is a schematic illustration of a data processing system configured for sensitive data management; and,

FIG. 3 is a flow chart illustrating a process for sensitive data management using an Android application.

### DETAILED DESCRIPTION OF THE INVENTION

Embodiments of the invention provide for sensitive data management in a mobile environment. The algorithm inputs raw hexadecimal values and dissociates data bytes for processing using the complex calculations stated above and UTF8 encoding technique. High complexity of derivation of sensitive data coded within C language makes extremely hard to understand and decode the values even if the .so file gets decompiled. In addition, thousands of junk and invalid functions as well as junk sensitive data in form of hexadecimal variables has been added to the same algorithm library (.so) which makes it more complex to understand and to separately identify and decode the valid sensitive data after code decompile.

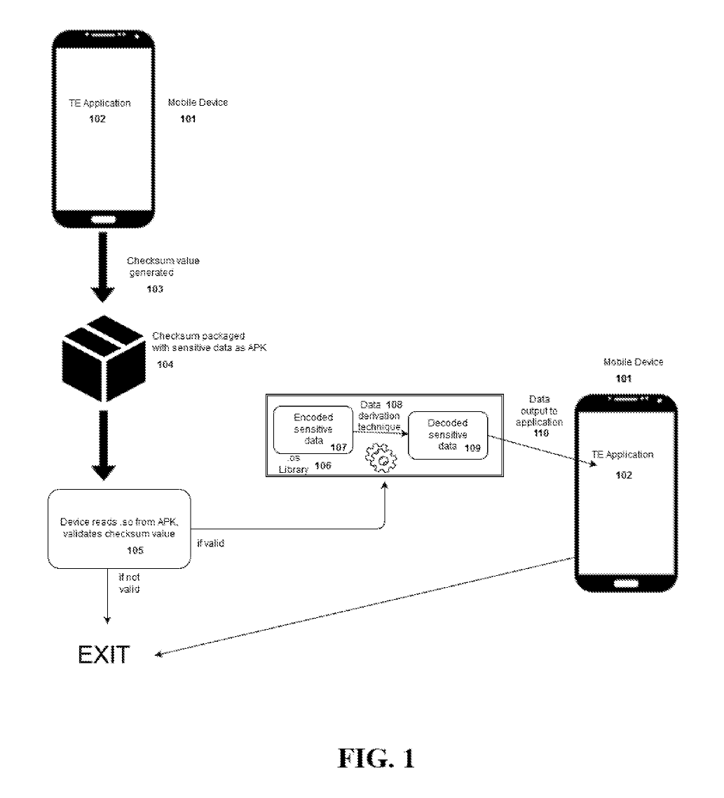

In further illustration, FIG. 1 pictorially shows a process for sensitive data management. As shown in FIG. 1, the sensitive data management algorithm defines a third layer of security which ensures the .so library 106 can only be accessed from within an Android application 102 codebase or classes. This ensures that the library 106 can never be accessed from outside attackers or third party or external code elements. Every Android APK (executable) has a checksum which is calculated based on the files and classes residing and bundled within the APK. The sensitive data management algorithm utilizes a checksum calculation process 103 for the generated Android application APK 104. This checksum is again non-directly stored within the .so library 106 by using a sensitive data value derivation technique 108. The Android APK 104 is re-generated after the checksum is non-directly stored within the library 106. Whenever a sensitive data is accessed from the sensitive data management library 106, the checksum of APK from where the sensitive data access request has been initiated is calculated and matched with the already derived checksum of the Android APK 104. If the two checksums are determined to be the same through a validation process 105, then the sensitive data value is derived via a data derivation technique 108. The application has different checksum in every APK release, so the same is updated in the sensitive data protection library (.so) every time before the release is done. External applications as well as attacker codes will not have access to .so file interfaces since the checksum for those APKs or classes will be different and access permission will fail.

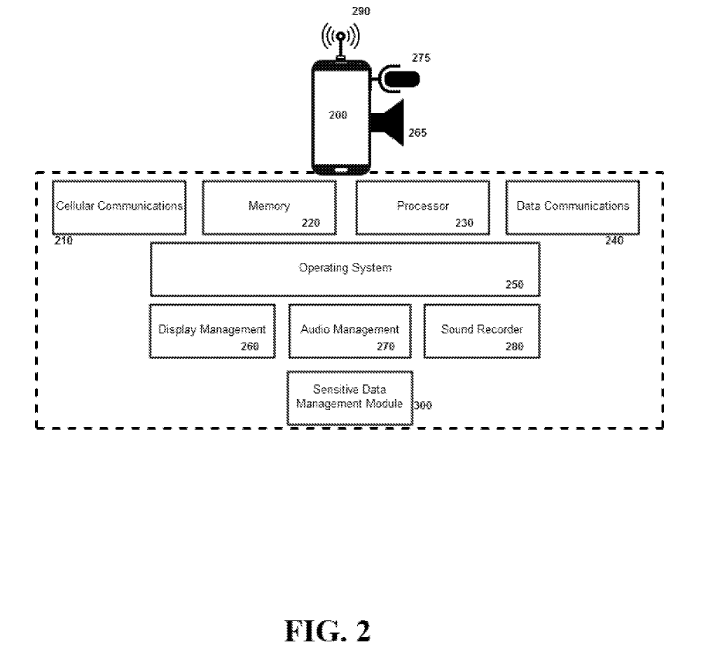

The process described in connection with FIG. 1 can be implemented in a data processing system. In further illustration, FIG. 2 schematically shows a data processing system configured for a sensitive data management module. The system can include a mobile device 200, for instance a smart phone, tablet computer or personal digital assistant. The mobile device 200 can include at least one processor 230 and memory 220. The mobile device 200 can include cellular communications circuitry 210 arranged to support cellular communications in the mobile device 200, as well as data communications circuitry 240 arranged to support data communications.

An operating system 250 can execute in the memory 220 by the processor 230 of the mobile device 200 and can support the operation of a number of computer programs, including a sound recorder 280. Further, a display management program 260 can operate through the operating system 250 as can an audio management program 270. Of note, a sensitive data management module 300 can be hosted by the operating system 250. The sensitive data management module 300 can include program code that, when executed in the memory 220 by the operating system 250, can act to manage sensitive data. In this regard, the program code of the sensitive data management module 300 is enabled to preserve sensitive data in a software layer only accessible by the application within the sensitive data management module 300.

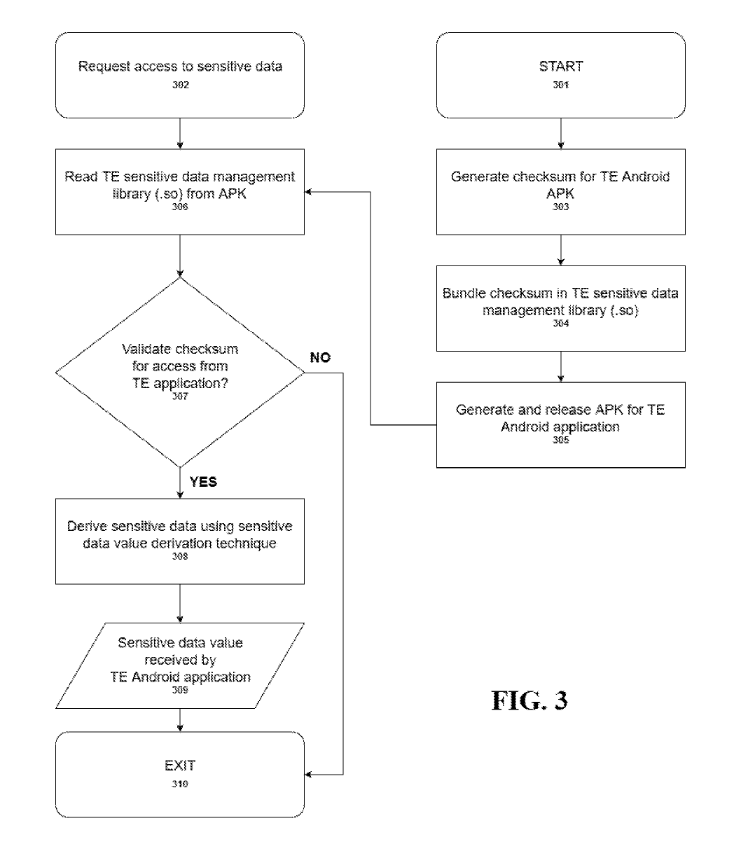

In even yet further illustration of the operation of the sensitive data management module 300, FIG. 3 is a flow chart illustrating the control flow of the sensitive data management library access. This process can begin at one of two starting positions: at application startup 301, or at a specific sensitive data access request 302. On application startup 301, a checksum value is generated for future use in a process 303. Next, the checksum is bundled along with sensitive data in a .so library in process 304. Thereafter, an APK is generated and released in process 305. If access to sensitive data is requested through process 302, processes 301 and 303-305 are disregarded. The .so library within the APK is then read by the application in process 306. The application then attempts to validate that the checksum value generated in process 303 matches that of the checksum value stored within the APK in process 307. If the values are not equal, then the program terminates in process 310. If the values are equal, then the sensitive data that was bundled in process 304 is derived in process 308. The data is then sent to the Android application 309 for output before the program terminates in process 310.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for sensitive data management, the method comprising:
loading source code defining a computer program;
selecting data to be utilized by the computer program during execution in a computing device;
compiling the source code into the computer program;
packaging the computer program into a package with the selected data disposed inside an application layer of the package; and,
deploying the package over a computer communications network to the computing device.

2. The method of claim 1, further comprising:
computing a checksum for the computer program;
bundling the checksum with the package; and,
responsive to a request by the computer program during execution in the computing device to access the selected data, retrieving the bundled checksum from the package, recomputing a checksum of the computer program, comparing the bundled checksum to the recomputed checksum and permitting access to the selected data only if the bundled checksum and recomputed checksum are determined to have the same value.

3. The method of claim 1, wherein the computer program is a mobile application.

4. The method of claim 1, wherein the computing device is a mobile phone.

5. The method of claim 1, wherein the package is an Android-type operating system Android package kit (APK) extended from a Java type archive.

6. A computer program product for sensitive data management, the computer program product including a computer readable storage medium having program instructions embodied therewith, the program instructions executable by a device to cause the device to perform a method including:
loading source code defining a computer program;
selecting data to be utilized by the computer program during execution in a computing device;
compiling the source code into the computer program;
packaging the computer program into a package with the selected data disposed inside an application layer of the package; and,
deploying the package over a computer communications network to the computing device.

7. The computer program product of claim 6, further comprising:
computing a checksum for the computer program;
bundling the checksum with the package; and,
responsive to a request by the computer program during execution in the computing device to access the selected data, retrieving the bundled checksum from the package, recomputing a checksum of the computer program, comparing the bundled checksum to the recomputed checksum and permitting access to the selected data only if the bundled checksum and recomputed checksum are determined to have the same value.

8. The computer program product of claim 6, wherein the computer program is a mobile application.

9. The computer program product of claim 6, wherein the computing device is a mobile phone.

10. The computer program product of claim 6, wherein the package is an Android-type operating system Android package kit (APK) extended from a Java type archive.
